(19) United States
(12) Patent Application Publication
(10) Pub. No.: US 2019/0004083 A1
(43) Pub. Date: Jan. 3, 2019

(54) SMART ACCELEROMETER CANTILEVER

(71) Applicant: Intell IP Corporation, Santa Clara, CA (US)

(72) Inventors: Sonja Koller, Regensburg (DE); Bernd Waidhas, Pettendorf (DE); Georg Seidemann, Landshut (DE); Stephan Stoeckl, Schwandorf (DE)

(21) Appl. No.: 15/638,590

(22) Filed: Jun. 30, 2017

(51) Int. Cl. G01P 15/125; G01P 1/02

(52) U.S. Cl. CPC G01P 15/125; G01P 2015/0828; G01P 1/023

(57) ABSTRACT

Techniques for an integrated circuit including an accelerometer are provided. In an example, an apparatus can include a unitary silicon substrate including a first portion and a second portion, wherein the first portion is thinner than the second portion, at least a portion of a sensor circuit configured to measure a deflection of the second portion with respect to the first portion, wherein the first portion is configured to anchor the accelerometer to a second device, and wherein the second portion is configured to deflect relative to the first portion in response to acceleration of the apparatus.

### TECHNICAL FIELD

The disclosure here in relates generally to sensors and more particularly to cantilever accelerometers.

### BACKGROUND

Electronic devices today include an amazing array of functionality. Activity monitoring via embedded accelerometers has become a much sought after capability of such electronic devices especially mobile electronic devices. MEMS type accelerometers have allowed the size and shape of accelerometers to shrink considerably, however, the fine structures of such devices are a manufacturing, reliability and cost burden.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally an integrated circuit system including an example smart accelerometer cantilever.

FIG. 2 illustrates an alternative integrated circuit system including an example smart accelerometer cantilever.

FIG. 3 illustrates generally a generic configuration of bulk semiconductor material for use as an example smart accelerometer cantilever based integrated circuit.

FIG. 4 illustrates a method of fabricating an integrated circuit with a smart accelerometer cantilever.

FIGS. 5A and 5B illustrate generally integrated circuit systems including an example smart accelerometer cantilever.

FIGS. 6A and 6B illustrate generally an example integrated circuit system with an integrated circuit that includes more than one smart accelerometer cantilever.

FIGS. 7A and 7B illustrate generally an example integrated circuit system with an integrated circuit that includes more than one smart accelerometer cantilever.

FIG. 8 illustrates an example integrated circuit with a smart accelerometer cantilever used for testing.

FIG. 9 illustrates a system level diagram, depicting an example of an electronic device (e.g., system) including integrated circuits with a smart accelerometer cantilever as described in the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

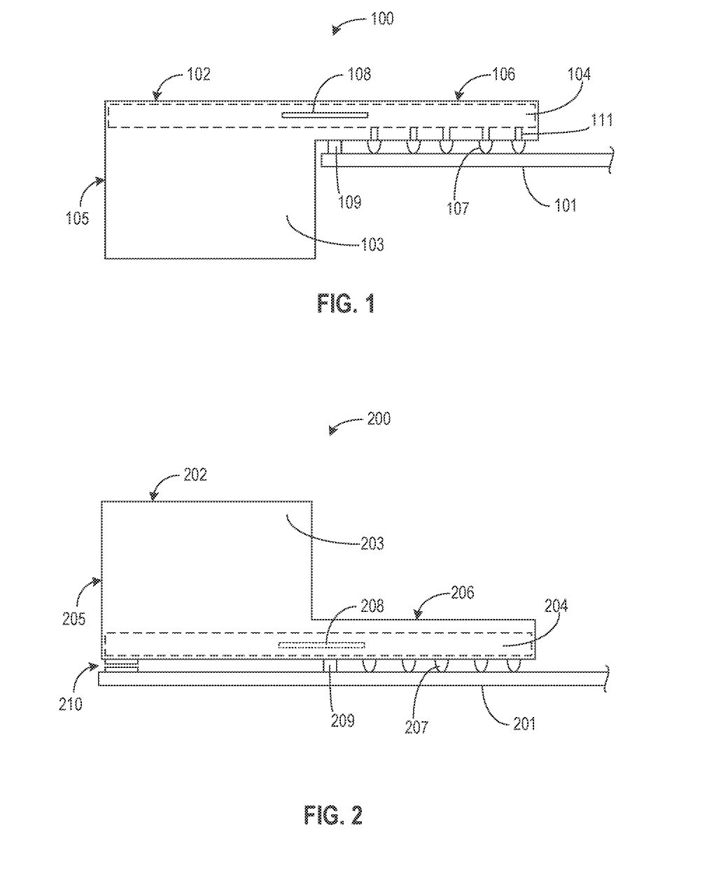

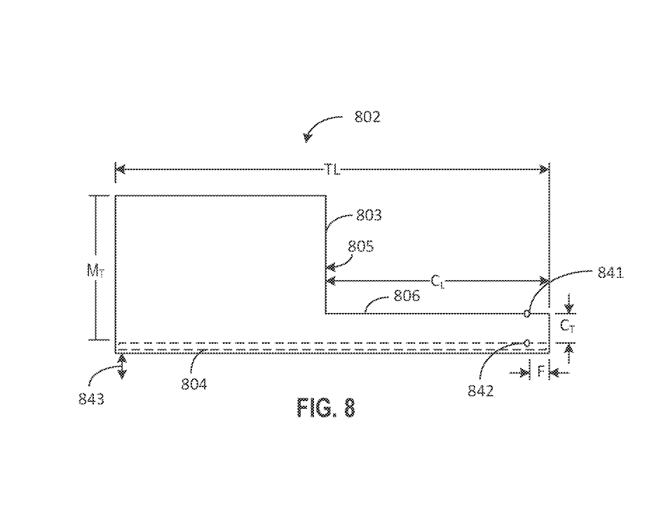

FIG. 1 illustrates generally an integrated circuit system 100 including an example smart accelerometer cantilever. The integrated circuit system 100 can include an application board 101 such as a printed circuit board (PCB) and an integrated circuit 102 including a smart accelerometer cantilever. The integrated circuit 102 can include a bulk and unitary semiconductor substrate 103 such as silicon, an area or layer of active devices 104 or sensor circuit, a mass portion 105 of the bulk semiconductor, a thinned portion 106 of the bulk semiconductor, and interconnects 107, such as solder balls, to electrically and mechanically couple or anchor the integrated circuit 102 to the application board 101. In certain examples, when the system 100 is subjected to acceleration, the mass portion 105 of the integrated circuit 102 can respond and deflect relative to the thinned portion 106 provided that the acceleration has a component in the general direction of the deflection movement. In certain examples, the integrated circuit 102 can include one or more strain gauges 108 spanning an interface of the mass portion 105 and the thinned portion 106. In some examples, the strain gauge may be positioned relative to the end of a fixation (F) as shown in FIG. 8, for example. In certain examples, the strain gauge 108 can include, but is not limited to, a bridge-based strain gauge, a transistor-based strain, a capacitor-based strain gauge, or combination thereof. The strain gauge 108 can convert the mechanical strain cause by the deflection of the mass portion 105 into an electrical representation of the strain. In certain examples, processing circuits within the layer of active devices 104 can process the electrical representation of the strain and provide acceleration information, strain information, or combinations thereof. In some examples, the integrated circuit 102 can be mounted to the application board using a dedicated support 109. The use of the dedicated support 109 can anchor and buffer at least some of the strain from the interconnects 107. In certain examples, through silicon vias (TSVs) 111 can couple the active electronics 104 of the integrated circuit 102 with the interconnects 107. In certain examples and as discussed below, the application board can be another integrated circuit such that the smart accelerometer cantilever can be integrated within an integrated circuit package or system-on-chip (SoC) package.

FIG. 2 illustrates an alternative integrated circuit system 200 including an example smart accelerometer cantilever. The integrated circuit system 200 can include an application board 201 such as a circuit board and an integrated circuit 202 including a smart accelerometer cantilever. The integrated circuit 202 can include a bulk and unitary semiconductor substrate 203 such as silicon, an area or layer of active devices 204 or a sensor circuit, a mass portion 205 of the bulk semiconductor, a thinned portion 206 of the bulk semiconductor, and interconnects 207, such as solder balls, to electrically and mechanically couple the integrated circuit 202 to the application board 201. In certain examples, when the system 200 is subjected to acceleration, the mass portion 205 of the integrated circuit 202 can deflect relative to the thinned portion 206 provided that the acceleration has a component in the general direction of the deflection movement. In certain examples, the integrated circuit 202 can include one or more strain gauges 208 spanning an interface of the mass portion 205 and the thinned portion 206. The strain gauge 208 can convert the mechanical strain cause by the deflection of the mass portion 205 into an electrical representation of the strain. In certain examples, processing circuits within the layer of active devices 204 can process the electrical representation of the strain and provide acceleration information, strain information, or combinations thereof. In some examples, the integrated circuit 202 can be mounted to the application board using a dedicated support 209. The use of the dedicated support 209 can anchor or buffer at least some of the strain from the interconnects 207. In addition to the strain gauge 208, or instead of the strain gauge 208, complementary plates or electrodes of a capacitor 210 can be fabricated on the application board 201 and the mass portion 205 of the bulk semiconductor substrate 203. As the mass portion 205 of the integrated circuit 202 deflects, the capacitance of the capacitor 210 can vary due to a change in distance between the plates of the capacitor 210. The change of capacitance can be measured by the active circuits 204 and can provide deflection information, acceleration information, or combinations thereof. In certain examples and as discussed below, the application board 201 can be another integrated circuit such that the smart accelerometer cantilever can be integrated within an integrated circuit package or system-on-chip (SoC) package.

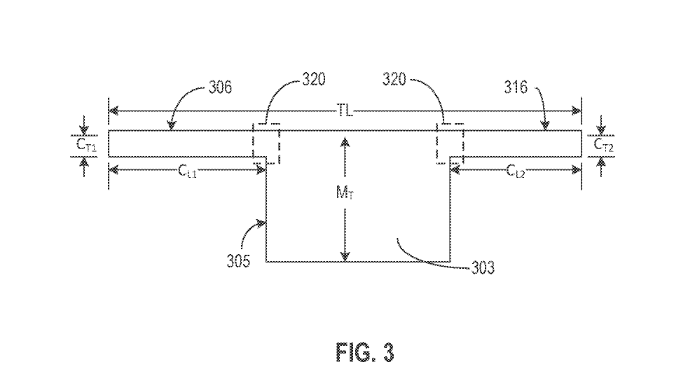

FIG. 3 illustrates generally a generic configuration of bulk semiconductor material for use as an example smart accelerometer cantilever based integrated circuit. Fabricating an integrated circuit with a smart accelerometer cantilever proceeds using the same steps as fabricating most other semiconductor-based integrated circuits with possibly a few additional straight-forward processing steps. One such step may involve using a thicker base substrate to provide an adequate mass portion 305. A second step can optionally involve thinning a portion of the substrate to create one or more thinned portions 306, 316 of the integrated circuit. FIG. 3 illustrates dimensions that can easily be controlled using standard fabrication techniques. Unlike other microelectromechanical system (MEMS) accelerometer structures that include sophisticated flexure mechanisms, the present examples rely on a simple, cantilever interface 320 between a thicker portion 305 of the substrate 303 and one or more thinner portions 306, 316 of the substrate 303. Referring again to FIG. 3, the configuration of the bulk and unitary semiconductor substrate 303 can include one or more thinned portions 306, 316 and a mass portion 305. In certain examples, the simple, cantilever interface 320 between a thinned portion 306, 316 and the mass portion 305 can be coextensive in two dimensions with a cross-section area of the thinned portion 306, 316. Stress at the cantilevered interface can be measured and used to indicate acceleration of the integrated circuit formed using the bulk semiconductor substrate material 303. Dimensions that can be easily controlled using straightforward processing methods include overall length (TL) of the integrated circuit, thickness (M_{T}) of the mass portion 305, number and configuration of the thinned portions 306, 316, length (C_{Lx}) of each thinned portion 306, 316, and thickness (C_{Tx}) of each thinned portion 306, 316.

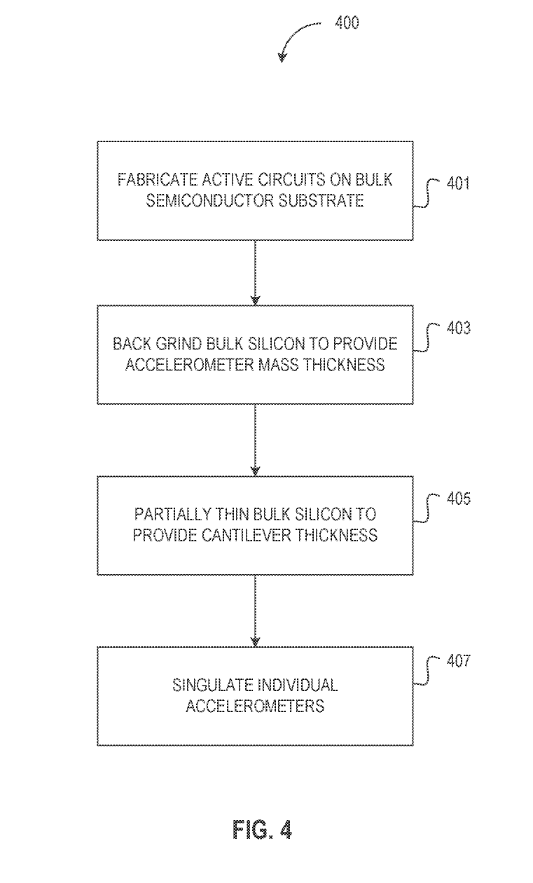

FIG. 4 illustrates a method of fabricating an integrated circuit with a smart accelerometer cantilever. At 401, active electronics can be fabricated on to a semiconductor substrate such as bulk silicon, for example, to form a plurality of integrated circuits. At 403, the substrate can be ground or milled to provide a desired accelerometer mass portion thickness. At 405, one or more portions of the semiconductor substrate can be thinned to provide the thinned portions of the integrated circuits. At 407, the individual integrated circuits with a smart accelerometer cantilever can be singulated, for example, from a wafer. It is understood that the various operations discussed above may be done in a different order to accommodate a particular integrated circuit configuration. Depending on the setup and the chosen measurement principle, bumper and supports (e.g., FIG. 1, 109) can be applied before mounting of the integrated circuit including the smart accelerometer cantilever. As an option, the air gap beneath the free hanging part of the substrate can be under filled with suitable material of low Young's modulus. The under fill can serve different purposes including but not limited to, quickly damping the motion of the mass portion to increase reaction times, suppressing stress peaks, increasing the capacity of an implementation as shown in FIG. 2 where the under fill material can include a high dielectric constant.

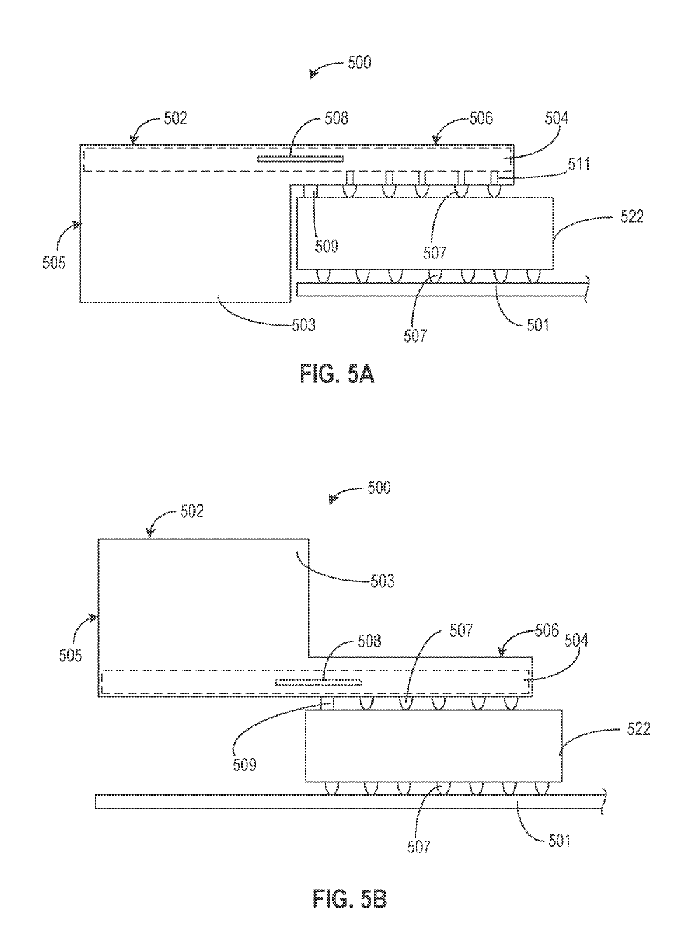

FIGS. 5A and 5B illustrate generally integrated circuit systems including an example smart accelerometer cantilever. The integrated circuit system 500 can include an application board 501 such as a circuit board and an integrated circuit 502 including a smart accelerometer cantilever. The integrated circuit 502 can include a bulk and unitary semiconductor substrate 503 such as silicon, an area or layer of active devices 504 or a sensor circuit, a mass portion 505 of the bulk semiconductor, a thinned portion 506 of the bulk semiconductor, and interconnects 507. In certain examples, the system 500 can include a second integrated circuit 522 disposed between the integrated circuit 502 and the application board 501. In certain examples, each of the integrated circuit 502 and the second integrated circuit 522 can include interconnects 507, such as solder balls, to electrically and mechanically couple each integrated circuit 502, 522 to the application board 501 or the other integrated circuit 522. In certain examples, when the system 500 is subjected to acceleration, the mass portion 505 of the integrated circuit 502 can deflect relative to the thinned portion 506 provided that the acceleration has a component in the general direction of the deflection movement. In certain examples, the integrated circuit 502 can include one or more strain gauges 508 spanning an interface of the mass portion 505 and the thinned portion 506. The strain gauge 508 can convert the mechanical strain cause by the deflection of the mass portion 505 into an electrical representation of the strain. In certain examples, processing circuits within the layer of active devices 504 can process the electrical representation of the strain and provide acceleration information, strain information, or combinations thereof. In some examples, the integrated circuit 502 can be mounted to the application board using a dedicated support 509. The use of the dedicated support 509 can anchor or buffer at least some of the strain from the interconnects 507. In certain examples, through silicon vias (TSVs) 511 can couple the active electronics of the integrated circuit 502 with the interconnects 507. FIG. 5A illustrates an integrated circuit system 500 with a mass portion 505 of the integrated circuit 502 oriented toward from the application board 501. FIG. 5B illustrates an integrated circuit system 500 with a mass portion 505 of the integrated circuit 502 oriented away from the application board 501.

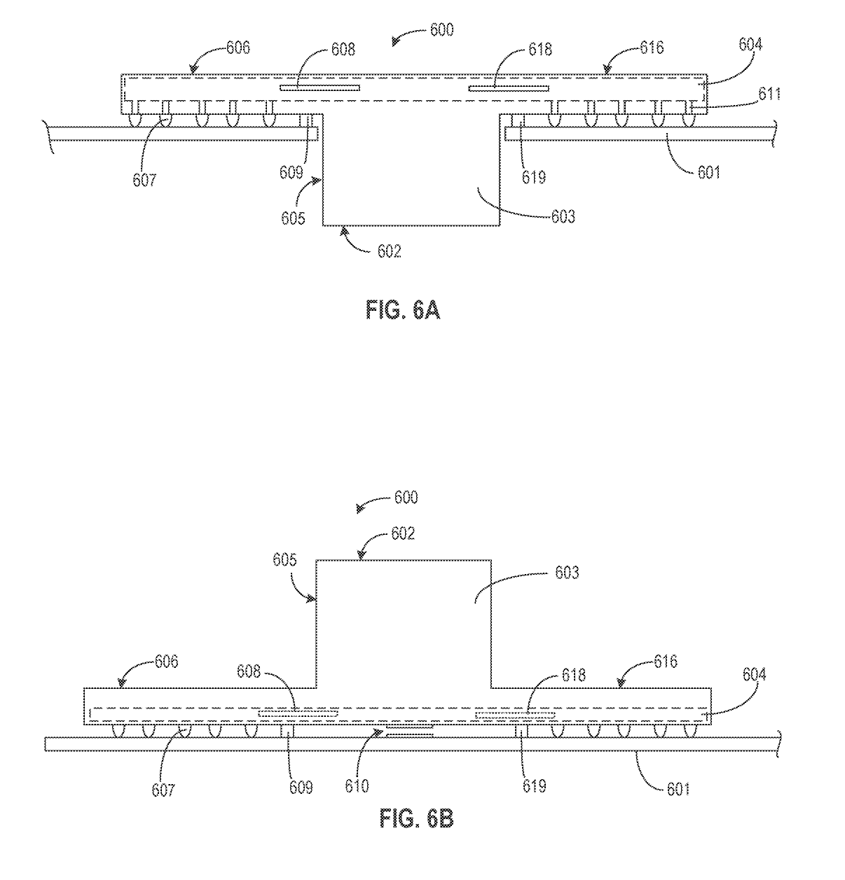

FIGS. 6A and 6B illustrate generally an example integrated circuit system 600 with an integrated circuit 602 that includes more than one smart accelerometer cantilever. The integrated circuit system 600 can include an application board 601 such as a circuit board and an integrated circuit 602 including more than one smart accelerometer cantilever. The integrated circuit 602 can include a bulk and unitary semiconductor substrate 603 such as silicon, an area or layer of active devices 604 or a sensor circuit, a mass portion 605 of the bulk semiconductor, first and second thinned portions 606, 616 of the bulk semiconductor, and interconnects 607, such as solder balls, to electrically and mechanically couple the integrated circuit 602 to the application board 601. In certain examples, when the system 600 is subjected to acceleration, the mass portion 605 of the integrated circuit 602 can deflect relative to each of the thinned portions 606, 616 provided that the acceleration has a component in the general direction of the deflection movement. In certain examples, the integrated circuit 602 can include one or more strain gauges 608, 618 spanning an interface of the mass portion 605 and the thinned portions 606, 616. Each strain gauge 608, 618 can convert the mechanical strain cause by the deflection of the mass portion 605 into an electrical representation of the strain. In certain examples, processing circuits within the layer of active devices 604 can process the electrical representation of the strain and provide acceleration information, strain information, or combinations thereof. In some examples, the integrated circuit 602 can be mounted to the application board 601 using one or more dedicated supports 609, 619. The use of the dedicated supports 609, 619 can anchor or buffer at least some of the strain from the interconnects 607. Referring to FIG. 6B, in addition to the strain gauges 608, 618, or instead of the strain gauges 608, 618, complementary plates or electrodes of a capacitor 610 can be fabricated on the application board 601 and the mass portion 605 of the bulk semiconductor substrate 603. As the mass portion 605 of the integrated circuit 602 deflects, the capacitance of the capacitor 610 can vary due to a change in distance between the plates of the capacitor 610. The change of capacitance can be measured by the active circuits 604 and can provide deflection information, acceleration information, or combinations thereof.

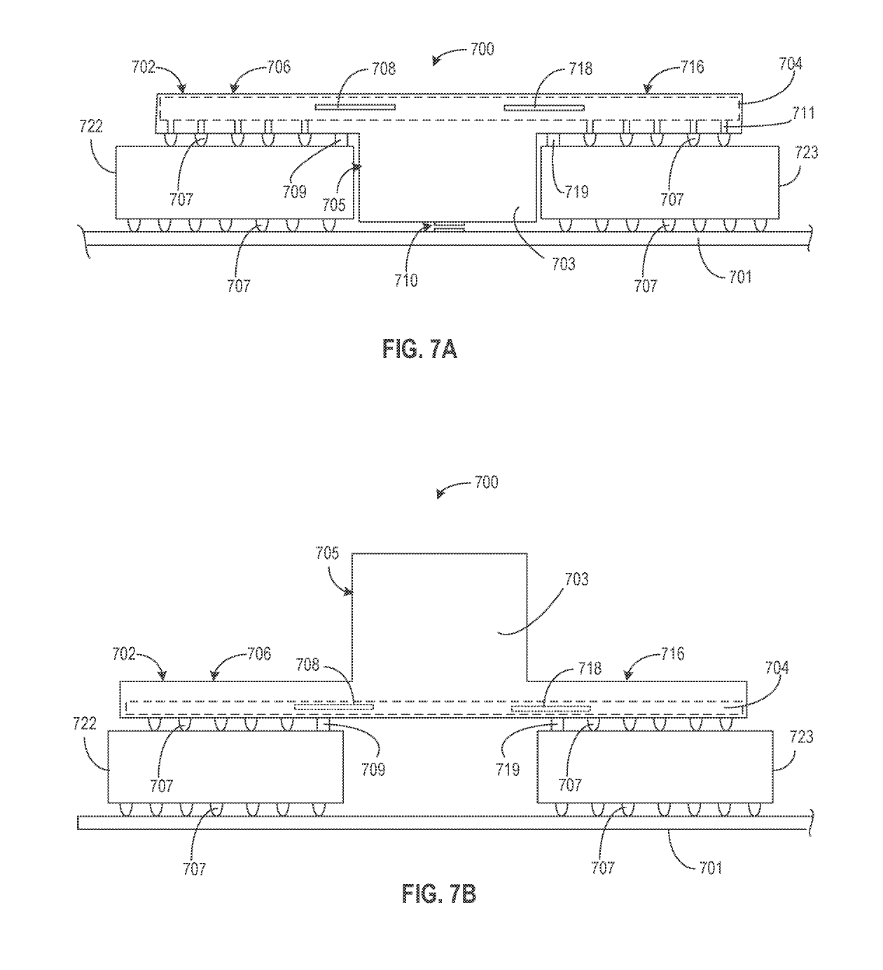

FIGS. 7A and 7B illustrate generally an example integrated circuit system 700 with an integrated circuit 702 that includes more than one smart accelerometer cantilever. The integrated circuit system 700 can include an application board 701 such as a circuit board and an integrated circuit 702 including more than one smart accelerometer cantilever. The integrated circuit 702 can include a bulk and unitary semiconductor substrate 703 such as silicon, an area or layer of active devices 704 or a sensor circuit, a mass portion 705 of the bulk semiconductor, first and second thinned portions 706, 716 of the bulk semiconductor, and interconnects 707. In certain examples, the system 700 can include a second integrated circuit 722 and optionally a third integrated circuit 723 disposed between the integrated circuit 702 and the application board 701. In certain examples, each of the integrated circuit 702 and the second integrated circuit 722 can include interconnects 707, such as solder balls, to electrically and mechanically couple each integrated circuit 702, 722, 723 to the application board 701 or the other integrated circuits 722, 723. In certain examples, when the system 700 is subjected to acceleration, the mass portion 705 of the integrated circuit 702 can deflect relative to the thinned portion 706 provided that the acceleration has a component in the general direction of the deflection movement. In certain examples, the integrated circuit 702 can include one or more strain gauges 708 spanning an interface of the mass portion 705 and the thinned portion 706. The strain gauge 708 can convert the mechanical strain cause by the deflection of the mass portion 705 into an electrical representation of the strain. In certain examples, processing circuits within the layer of active devices 704 can process the electrical representation of the strain and provide acceleration information, strain information, or combinations thereof. In some examples, the integrated circuit 702 can be mounted to the application board using a one or more dedicated supports 709, 719. The use of the dedicated support 709, 719 can anchor or buffer at least some of the strain from the interconnects 707. In certain examples, through silicon vias (TSVs) 711 can couple the active electronics of the integrated circuit 702 with the interconnects 707. Referring to FIG. 7A, in addition to the strain gauges 708, 718, or instead of the strain gauges 708, 718, complementary plates or electrodes of a capacitor 710 can be fabricated on the application board 701 and the mass portion 705 of the bulk semiconductor substrate 703. As the mass portion 705 of the integrated circuit 702 deflects, the capacitance of the capacitor 710 can vary due to a change in distance between the plates of the capacitor 710. The change of capacitance can be measured by the active circuits 704 and can provide deflection information, acceleration information, or combinations thereof.

FIG. 8 illustrates an example integrated circuit 802 with a smart accelerometer cantilever used for testing. The integrated circuit 802 can include a bulk and unitary semiconductor substrate 803 such as silicon, an area or layer of active devices 804 or a sensor circuit, a mass portion 805 of the bulk semiconductor, a thinned portion 806 of the bulk semiconductor. The total length (TL) of the integrated circuit was 15 mm. The thickness (M_{T}) of the mass portion was 0.775 mm. The length (C_{L}) of the cantilever or thinned portion 806 was 3 mm. The thickness (C_{T}) of the cantilever or thinned portion was 23 μm. The integrated circuit was fixed at the distal end of the thinned portion 806. The fixation length (F) was about 0.6 mm. By the means of finite-element simulation, the integrated circuit was subjected to various accelerations and various measurements were recorded. For example, the measurements includes a first principal stress 841 measured at an external surface point of the thinned portion, opposite the active devices of the integrated circuit 802, and near an extent of the fixation, a uniaxial stress 842 measured at a surface of the active devices near the extent of the fixation, and displacement 843 of the distal end of the mass portion 805. The simulation results (maximum values) are summarized in Table 1.

TABLE 1

| | Uniaxial Stress | 1^{st} Principal Stress | Displacement |
|---|---|---|---|
| Acceleration | (MPa) | (MPa) | (μm) |
| g = 9.81 m/sec² | −21 | 20 | 8 |
| 5 g | −70 | 83 | 26 |
| 10 g | −103 | 135 | 38 |
| 20 g | −148 | 215 | 57 |
| 30 g | −239 | 391 | 78 |
| 40 g | −342 | 609 | 103 |

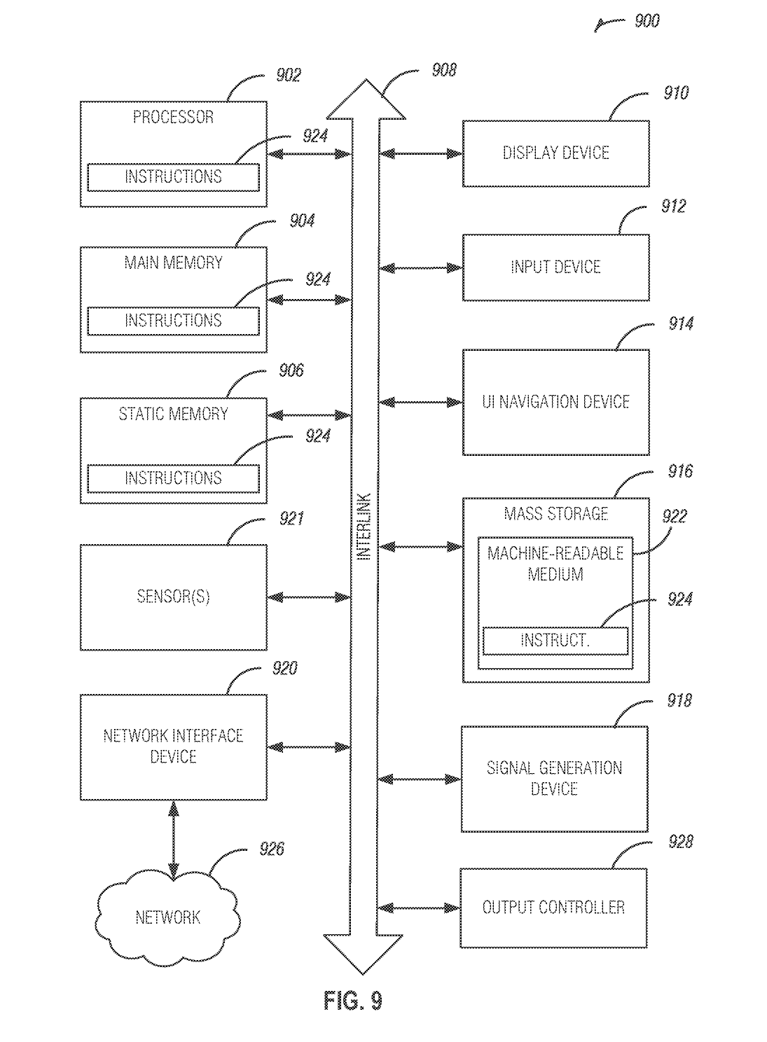

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (or other distributed) network environment. As used herein, peer-to-peer refers to a data link directly between two devices (e.g., it is not a hub- and spoke topology). Accordingly, peer-to-peer networking is networking to a set of machines using peer-to-peer data links. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer such as a smart accelerometer having a cantilever as discussed above, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein.

The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### Additional Examples and Notes

In Example 1,

The above detailed description includes references to the accompanying drawings, which form a part of the detailed description. The drawings show, by way of illustration, specific embodiments in which the subject matter may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the present subject matter should be determined with reference to the appended claims, along with the full scope of equivalents to which such claims are legally entitled.

What is claimed is:

1. An accelerometer comprising:
a unitary silicon substrate including a first portion and a second portion, wherein the first portion is thinner than the second portion;
at least a portion of a sensor circuit configured to measure a deflection of the second portion with respect to the first portion;
wherein the first portion is configured to anchor the accelerometer to a second device; and
wherein the second portion is configured to deflect relative to the first portion in response to acceleration of the accelerometer.

2. The accelerometer of claim 1, including a plurality of electrical interconnects configured to at least partially anchor the unitary silicon substrate to the second device.

3. The accelerometer of claim 1, including a first major surface coextensive with the first portion and the second portion.

4. The accelerometer of claim 3, wherein the first major surface includes active integrated devices.

5. The accelerometer of claim 1, wherein the second portion of the sensor includes a portion of a capacitor.

6. The accelerometer of claim 1, wherein the sensor circuit includes a strain gauge circuit located at an interface of the first portion and the second portion.

7. The accelerometer of claim 1, including the second device.

8. The accelerometer of claim 7, wherein the second device is a printed circuit board

9. The accelerometer of claim 7, wherein the second device is a second integrated circuit

10. The accelerometer of claim 7, wherein the second device includes a mechanical support to buffer deflection forces from the plurality of electrical interconnects.

11. The accelerometer of claim 1, including a third portion of the unitary substrate, wherein the second portion is located between the first portion and the third portion, and wherein the third portion is thinner than the second portion.

12. The accelerometer of claim 11, wherein the second portion is configured to deflect relative to the third portion in response to acceleration of the accelerometer.

13. The accelerometer of claim 11, wherein the third portion is configured to anchor the accelerometer to the second device.

14. The accelerometer of claim 11, wherein the third portion is configured to anchor the accelerometer to a third device.

15. The accelerometer of claim 1, wherein an interface between the first portion and the second portion is coextensive in two directions with a cross-section area of the first portion.

16. A method of manufacturing an integrated circuit with an accelerometer cantilever, the method comprising:
fabricating active electronic devices on to a first major surface of a semiconductor substrate to form a plurality of integrated circuits;
grinding a second major surface of the semiconductor substrate to provide a desired thickness of a mass portion of the accelerometer;
thinning the semiconductor substrate via the second major surface to provide a thinned portion, wherein an interface of the mass portion and the thinned portion is coextensive in two directions with a cross-section of the thinned portion.

17. The method of claim 16, wherein the fabricating the active electronic devices includes fabricating a strain gauge configured to measure strain at the interface.

18. The method of claim 17, including fabricating interconnects to provide external electrical connections to the active devices.

19. The method of claim 18, wherein the fabricating interconnects includes fabricating interconnects on the first major surface of the substrate to provide external electrical connections to the active devices.

20. The method of claim 18, wherein the fabricating interconnects includes:
fabricating interconnects on the second major surface of the substrate to provide external electrical connections to the active devices; and
fabricating through silicon vias from the second major surface to the active electronic devices.

21. The method of claim 16, including fabricating at least a portion of a capacitor on to the mass portion.
